(19) United States
(12) Patent Application Publication
(10) Pub. No.: US 2021/0096959 A1
(43) Pub. Date: Apr. 1, 2021

(54) LOSS FREE LONG DISTANCE ACTIVE-ACTIVE SITES CONFIGURATION

(71) Applicant: INTERNATIONAL BUSINESS MACHINES CORPORATION, ARMONK, NY (US)

(72) Inventors: David PETERSEN, Great Falls, VA (US); Paul M. CADARETTE, Hemet, CA (US); Serge BOURBONNAIS, Palo Alto, CA (US); Michael Gerard FITZPATRICK, Raleigh, NC (US); John Simon TILLING, Grantham (GB); Pamela L. MCLEAN, Raleigh, NC (US); Gregory Walter VANCE, Morgan Hill, CA (US); Matthew J. WARD, VAIL, AZ (US); Theresa Mary BROWN, Tucson, AZ (US); Nicolas Marc CLAYTON, Warrington (GB); Wei LIU, Beijing (CN); Hua ZHU, Shanghai (CN); Xing Jun ZHOU, Shanghai (CN)

(21) Appl. No.: 16/585,110

(22) Filed: Sep. 27, 2019

(51) Int. Cl. G06F 11/14; G06F 16/24; G06F 16/27

(52) U.S. Cl. CPC G06F 11/1464; G06F 11/1461; G06F 16/275; G06F 16/24; G06F 16/273; G06F 11/1466

(57) ABSTRACT

Aspects of the invention include a continuous availability for workload and site switches with no data loss at unlimited distances in an active-active sites configuration. A non-limiting example computer-implemented method includes synchronously replicating commit records of changed workload data, by a processor, from an active site to a bunker site upon a workload data commit. The method asynchronously replicates committed transactions on changed workload data, by the processor, from the bunker site to a recovery site.

### BACKGROUND

The present invention generally relates to workload switching, and more specifically, to loss free long distance active-active sites configuration.

Disaster recovery solutions require a recovery site to be continuously updated and available with workload data from a main site. In order to eliminate data loss, these recovery sites had to be located within a short distance of the main site. Safe location of loss-free recovery sites a long distance from the main site has been elusive.

### SUMMARY

Embodiments of the present invention are directed to continuous availability for workload and site switches with no data loss at unlimited distances in an active-active sites configuration. A non-limiting example computer-implemented method includes synchronously replicating commit records of changed workload data, by a processor, from an active site to a bunker site upon a workload data commit. The method asynchronously replicates committed transactions on changed workload data, by the processor, from the bunker site to a recovery site.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 illustrates a block diagram of components of an active-active site in accordance with one or more embodiments of the present invention;

FIG. 2 illustrates a flow diagram of a process for a zero data loss active-active site configuration in accordance with one or more embodiments of the present invention;

FIG. 3 illustrates a cloud computing environment in accordance with one or more embodiments of the present invention;

FIG. 4 illustrates a set of functional abstraction layers provided by the cloud computing environment in accordance with one or more embodiments of the present invention; and

FIG. 5 illustrates a computer system in accordance with one or more embodiments of the present invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments of the present invention provide continuous availability between sites that are geographically separated from each other, and more specifically, to a multi-site continuous availability computing environment with zero data loss in case of an outage of a site. This is accomplished through synchronous replication from a main site to a bunker site, with asynchronous replication from the bunker site to a recovery site.

In the past, some computer availability and disaster recovery solutions were limited to a maximum distance between sites. Other past solutions required starting systems, applications, and supporting infrastructure on the recovery site that could in some cases take several hours to restart. Some past solutions additionally required modifications to software applications, such as database servers, and hardware, such as routers and switches, in order to implement various disaster recovery and continuous availability functions, resulting in relatively high implementation cost. Some past solutions operated at a site level, rather than at a workload level.

Thus, some existing availability systems are limited geographically and/or by recovery time. When one or more workloads are spread across multiple servers in a single location, the servers for each workload may share a single data repository, and all data related to each of the workloads may be stored in the same location. When the workloads are split among geographically separated sites, a single data repository for each workload is not always feasible.

In these instances, data from the one or more workloads may be stored in a data repository at a primary site, and the data may be asynchronously replicated between the primary site and a copy of the data at the recovery site. The delay between the time a transaction is committed at the primary site and the time it is committed at the recovery site is called the replication latency. As sites are spread further apart geographically, latency may increase because of the time it takes to move the data over a network in order to synchronize it. For instance, in some implementations, one millisecond of latency is added per 100 fiber kilometers between the sites. As the distance between sites increases, the latency increases and may increase above what is tolerable for a given workload. Because replication occurs asynchronously, this may result in data loss if there is a sudden unplanned outage and some data isn't replicated.

As a result, some existing availability systems provide acceptable workload performance only within a limited geographic area. In some cases, this limited geographic area may be approximately 10 to 20 fiber kilometers (i.e., 10 to 20 linear kilometers of a fiber optic network).

Disaster recovery systems are designed to switch between a primary data center and a recovery data center in situations where the primary data center becomes unavailable, such as, for example, during a power outage. For example, during normal operation all transactions may be distributed to the primary data center and the data may be periodically replicated bit-by-bit to the recovery data center.

Workloads generally may be executed in parallel on at least two distinct computing systems. Typically, at least two instances of a workload may be executed virtually simultaneously on at least two geographically separated computing systems, for example, an active instance executing on a computing system at a primary site and a standby instance executing on another computing system at a recovery site. Such a configuration may sometimes be referred to in the art as an active-active workload.

The distance between sites may include, for example, distances greater than the area covered within a metro area network (MAN), that is, a network that may span distances measured in tens of kilometers, for example, up to about 20 fiber kilometers. Some customers require that a primary site and a recovery site be separated by distances sufficient to ensure that a disaster affecting one site is not likely to affect the other. Although these distances vary based on regional and environmental conditions, primary and recovery sites sometimes are separated by distances that extend beyond a MAN.

A customer acceptability window may be measured by the length of a recovery point objective (“RPO”). An RPO, as known in the art, is the unit of time up to which the recovery site's data is current after the primary site becomes unavailable. That is, an RPO defines the maximum targeted time period in which data might be lost after the primary site becomes unavailable. For example, the customer acceptable window may require an RPO of zero seconds of data loss when an unplanned interruption occurs.

A workload may be made up of one or more computing applications or jobs, as well as associated middleware runtime environments, data source objects used by the applications, and the network addressability of the applications. A workload may consist of one or more computing applications, jobs or threads that are relatively time-sensitive and preferably will not be suspended at all, not even for a brief moment. A workload includes a database, or a file system, a set of applications or resources that use, access and/or manage the database and/or file system.

A unit of work data may include one or more computing transactions and/or processes substantially performed as a group to service one or more requests. A unit of work data may include, for example, data generated by or otherwise associated with a single computing transaction and/or process, or with multiple computing transactions and/or processes substantially performed as a group to service one or more requests. A data object may include, for example, any combination of related or associated data.

A continuous availability system may include a workload distribution module that collects metrics at the software application, middleware, operating system, network, and hardware levels for each workload. The continuous availability system may use the collected metrics to provide continuous availability and workload redirection capabilities across multiple computing sites.

Some prior systems provide systems and methods for achieving zero-data-loss recovery in an active-active sites configuration with a recovery time objective (“RTO”) measured in seconds, or at most a few minutes, for transactions that require data updates and sub-second for read-only transactions that can tolerate temperate data staleness, following an outage of a site. An RTO, as known in the art, is the maximum amount of time needed to begin normal operations after the primary site experiences an outage. The embodiments of the invention switch transactions to a geographically remote site where a remote read-only standby sharing workload coupled with a synchronous disk replication of recover logs is used for fast restart and for preventing data loss (zero RPO). Whenever the term “logs” is used in this description, the reference is to both logs and artifacts. Asynchronous log capture replication of the workloads to another data sharing parallel system is used for uninterrupted service.

Prior clustered systems solutions provide RTO of less than a minute for planned or unplanned workload or site outages. While reference in this description will be to clusters, one skilled in the art after reading this disclosure will appreciate that clusters may refer to both a single system and multiple systems. Prior continuous availability solutions consist of two clusters executing the same workload and having the same data with the clusters kept in synchronization by using software replication. In the event of planned or unplanned outages, the solution will redirect connections to the workload instance on the other cluster. As stated earlier, the software replication is performed asynchronously, and this may result in data loss if there is a sudden unplanned outage and some data isn't replicated. Prior solutions described above rectified this situation when two clusters were within metro mirror (MM) synchronous replication distance having tolerable signal latency impact (roughly a maximum distance of 100 fiber kilometers).

Prior to the introduction of zero data loss systems described above at a metro distance capability, a capture engine at a cluster A in site 1 reads the operational database logs looking for committed units of work (“UoW”), with the capture engine sending the information over the network to an apply engine on cluster B in site 2 which replays database transactions using a database interface, such as a database structured query language (“SQL”), to apply the update to the operation of the database on cluster B. While examples using relational databases will be used throughout this description, embodiments of the present invention may be used with any database types.

With zero data loss at metro distance capability, an operational database on cluster A in site 1 has its logs, etc. on a disk subsystem that are synchronously MM replicated to a database in site 2. When a database UoW commit is performed, the commit record is synchronously replicated from site 1 to site 2 prior to SQL commit completing. This results in all the committed UoW records in the database log being in both site 1 and site 2 (this assumes the MM remains in a duplex state). The database management system for a database capture engine is modified to read off MM secondary volumes. The database capture engine resides on cluster B. The database capture engine in cluster B in site 2 reads the database logs looking for committed UoWs, and the capture engine sends the information over the network to the apply engine also on cluster B in site 2. The apply engine replays the database SQL to apply the update to the database management system on cluster B. In the event of an unplanned workload outage in site 1 or site 1 outage, there is no data loss since all the committed UoWs are located in site 2

This is known as an asymmetric zero data loss (“ZDL”) at metro distance configuration. Optionally the same set-up could be established from cluster B to cluster A and this will be known as a symmetric ZDL at metro distance configuration.

However, when the two clusters are separated by more than the MM synchronous replication distance, there is no zero data loss capability.

Embodiments of the present invention build upon the zero data loss capability for active-active sites configurations systems described above by providing a ZDL at unlimited distance capability when there is extended distance between the two clusters.

Embodiments of the present invention improve upon ZDL at MM distance capability by providing the operational database management system (“DBMS”) on cluster A in site 1 having its logs on a storage disk subsystem which are synchronously MM replicated to a bunker site, site 2. A commit record is synchronously replicated from site 1 to site 2 when a database UoW commit is performed prior to SQL commit completing, and a data replication engine for a database capture engine on cluster B in a site 3 reads the database logs looking for committed UoWs. The capture engine sends the information over the network to an apply engine also on cluster B in site 3, and the apply engine replays the database SQL to apply the update to the database DBMS on cluster B.

In embodiments of the present invention with the ZDL at unlimited distance capability, the operational database DBMS on cluster A in site 1 has its logs on a storage disk subsystem, and they are synchronously MM replicated to a storage system in a bunker site and then asynchronously global mirrored (“GM”) to a database in a recovery region. When a database UoW commit is performed, the commit record is synchronously replicated from site 1 to the bunker site and then asynchronously GM from the bunker site to the recovery site. This results in all the committed UoW records in the database log being in both site 1 and eventually in the recovery site (this assumes the MM remains in a duplex state and GM continues to generate consistency groups). The improvements made for ZDL at metro distance capability, described previously, are also applicable to ZDL at unlimited distance capability.

In the event of an unplanned workload outage in site 1 or site 1 outage, assuming the bunker site survives the outage, there is no data loss since all the committed UoWs are located in site 2. This is known as an asymmetric ZDL at unlimited distance configuration. Optionally, the same set-up could be established from cluster B to cluster A, and this is known as a symmetric ZDL at unlimited distance configuration.

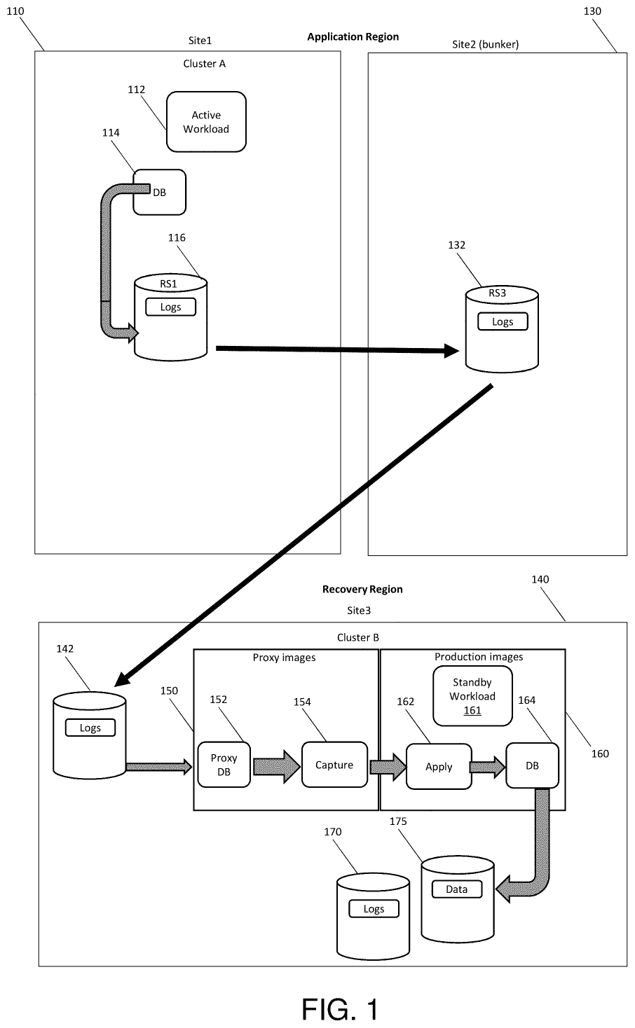

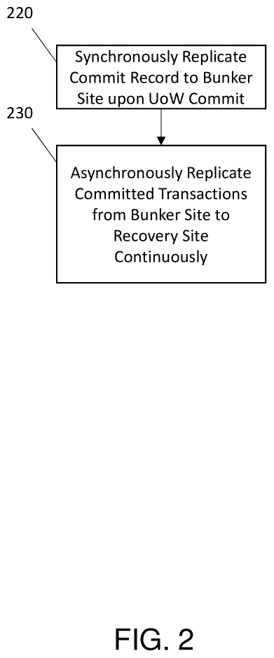

Turning now to FIG. 1, an active-active site is generally shown in accordance with one or more embodiments of the present invention. The devices embodying the present invention will be described in FIG. 1 with the operation of the devices discussed with respect to FIG. 2. An Application Region contains a first site, Site 1 110, containing an active workload 112 and active database 114 of transactions, along with a bunker site, Site 2 130. The active workload 112 may include transaction processing applications, database applications, queue and queue management operations, and the like. In addition, there is a Recovery Region at a Site 3 140. Site 3 140 includes proxy images 150 and production images 160.

Site 1 110 and Site 3 140 may be geographically distributed computing sites located thousands of fiber kilometers apart, while Site 1 110 and Site 2 130 are typically located less than 100 fiber kilometers apart. For example, Site 1 110 may be located in one region, for example the Application Region, and Site 3 140 may be located in another region, for example, the Recovery Region, that is geographically distant from the Application Region. The geographic distance between the Application Region and the Recovery Region may provide for a relatively high probability that computer processing sites in the Recovery Region will not suffer outages, or otherwise become unavailable, at the same time as computer processing sites in the Application Region. In particular, the geographic distance between the regions may provide for a relatively high probability that computer processing sites in the two regions will not suffer outages, or otherwise become unavailable, due to a common cause, such as a regional power outage or natural disaster.

Returning to Site 1 110, changes to the active database 114 are stored in logs in a primary disk replication site (“RS”) 1, RS1. At the bunker site, Site 2 130, a third storage, RS3 132, stores a partial backup using metro mirror synchronous replication.

In the Recovery Region wherein Site 3 140 is located, there is a backup storage 142 that includes a copy of the logs that have been asynchronously global mirrored. Proxy images 150 having a proxy database 152 and a capture engine 154 and production images 160 having a standby workload 161, an apply engine 162 and a database 164 are also stored in Site 3 140. A recovery storage 170 and associated storage 175 holds database 164. Multiple times a second, the capture engine 154 calls the proxy database 152 which then reads, using asynchronous global mirroring, the secondary disk 142.

FIG. 2 illustrates a flow diagram of a process for a zero data loss active-active site configuration in accordance with one or more embodiments of the present invention. When a database unit of work (UoW) commit is performed at Site 1 110, the commit record is synchronously replicated from Site 1 110 to the bunker site at Site 2 130 (block 220). The UoW is asynchronously globally mirrored from the bunker at Site 2 130 to Site 3 140 (block 230). This results in all the committed UoW records in the logs being in both Site 1 110 and eventually in Site 3 140. This assumes the synchronous mirroring to the bunker at Site 2 130 remains in a duplex state and asynchronous global mirroring continues to generate consistency groups.

The database capture engine 154 on cluster B in a Site 3 140 reads the database logs looking for committed UoWs. The capture engine 154 sends the information over the network to the apply engine 162 also on cluster B in Site 3 140, and the apply engine 162 replays the database SQL to apply the updates to the database 164 on cluster B.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

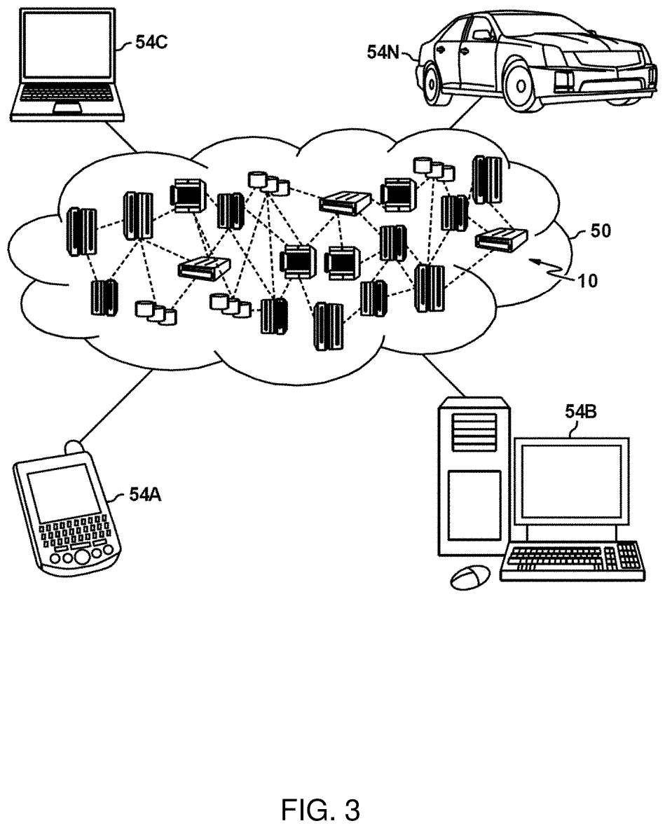

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

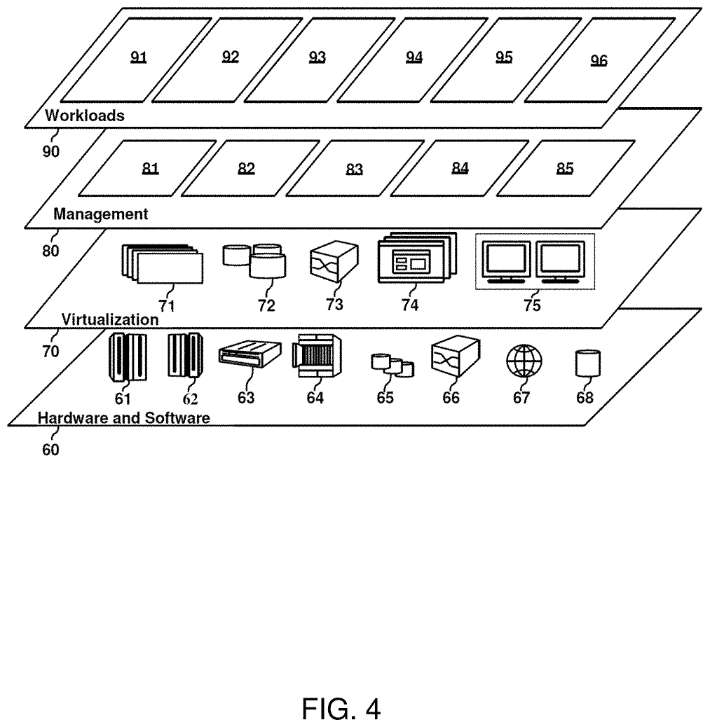

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Secure service container-based virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and recovery processing 96

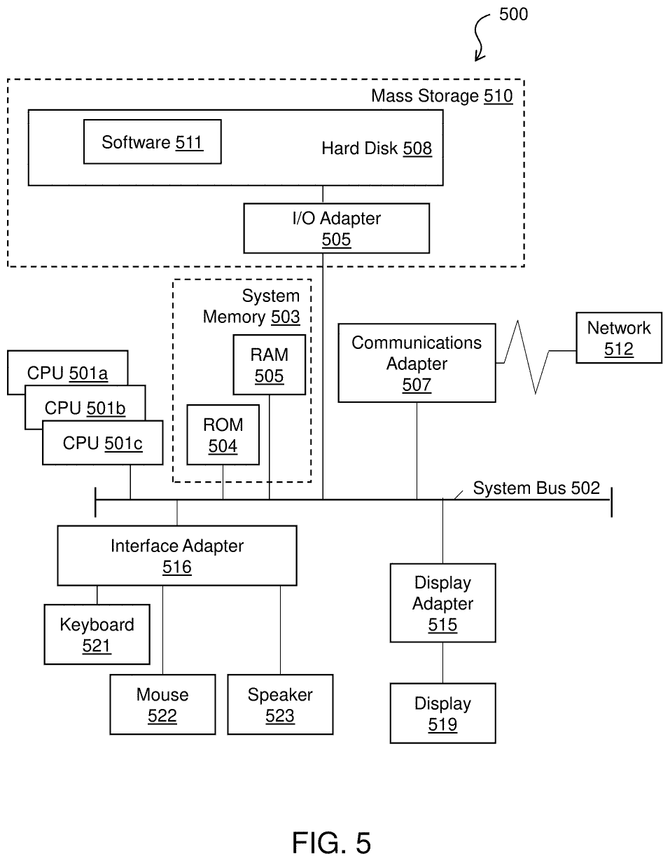

Turning now to FIG. 5, a computer system 500 is generally shown in accordance with an embodiment. The computer system 500 can be an electronic, computer framework comprising and/or employing any number and combination of computing devices and networks utilizing various communication technologies, as described herein. The computer system 500 can be easily scalable, extensible, and modular, with the ability to change to different services or reconfigure some features independently of others. The computer system 500 may be, for example, a server, desktop computer, laptop computer, tablet computer, or smartphone. In some examples, computer system 500 may be a cloud computing node. Computer system 500 may be described in the general context of computer system executable instructions, such as program modules, being executed by a computer system. Generally, program modules may include routines, programs, objects, components, logic, data structures, and so on that perform particular tasks or implement particular abstract data types. Computer system 500 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, the computer system 500 has one or more central processing units (CPU(s)) 501a, 501b, 501c, etc. (collectively or generically referred to as processor(s) 501). The processors 501 can be a single-core processor, multi-core processor, computing cluster, or any number of other configurations. The processors 501, also referred to as processing circuits, are coupled via a system bus 502 to a system memory 503 and various other components. The system memory 503 can include a read only memory (ROM) 504 and a random access memory (RAM) 505. The ROM 504 is coupled to the system bus 502 and may include a basic input/output system (BIOS), which controls certain basic functions of the computer system 500. The RAM is read-write memory coupled to the system bus 502 for use by the processors 501. The system memory 503 provides temporary memory space for operations of said instructions during operation. The system memory 503 can include random access memory (RAM), read only memory, flash memory, or any other suitable memory systems.

The computer system 500 comprises an input/output (I/O) adapter 506 and a communications adapter 507 coupled to the system bus 502. The I/O adapter 506 may be a small computer system interface (SCSI) adapter that communicates with a hard disk 508 and/or any other similar component. The I/O adapter 506 and the hard disk 508 are collectively referred to herein as a mass storage 510.

Software 511 for execution on the computer system 500 may be stored in the mass storage 510. The mass storage 510 is an example of a tangible storage medium readable by the processors 501, where the software 511 is stored as instructions for execution by the processors 501 to cause the computer system 500 to operate, such as is described herein below with respect to the various Figures. Examples of computer program product and the execution of such instruction is discussed herein in more detail. The communications adapter 507 interconnects the system bus 502 with a network 512, which may be an outside network, enabling the computer system 500 to communicate with other such systems. In one embodiment, a portion of the system memory 503 and the mass storage 510 collectively store an operating system, which may be any appropriate operating system, such as the z/OS or AIX operating system from IBM Corporation, to coordinate the functions of the various components shown in FIG. 5.

Additional input/output devices are shown as connected to the system bus 502 via a display adapter 515 and an interface adapter 516 and. In one embodiment, the adapters 506, 507, 515, and 516 may be connected to one or more I/O buses that are connected to the system bus 502 via an intermediate bus bridge (not shown). A display 519 (e.g., a screen or a display monitor) is connected to the system bus 502 by a display adapter 515, which may include a graphics controller to improve the performance of graphics intensive applications and a video controller. A keyboard 521, a mouse 522, a speaker 523, etc. can be interconnected to the system bus 502 via the interface adapter 516, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 5, the computer system 500 includes processing capability in the form of the processors 501, and, storage capability including the system memory 503 and the mass storage 510, input means such as the keyboard 521 and the mouse 522, and output capability including the speaker 523 and the display 519.

In some embodiments, the communications adapter 507 can transmit data using any suitable interface or protocol, such as the internet small computer system interface, among others. The network 512 may be a cellular network, a radio network, a wide area network (WAN), a local area network (LAN), or the Internet, among others. An external computing device may connect to the computer system 500 through the network 512. In some examples, an external computing device may be an external webserver or a cloud computing node.

It is to be understood that the block diagram of FIG. 5 is not intended to indicate that the computer system 500 is to include all of the components shown in FIG. 5. Rather, the computer system 500 can include any appropriate fewer or additional components not illustrated in FIG. 5 (e.g., additional memory components, embedded controllers, modules, additional network interfaces, etc.). Further, the embodiments described herein with respect to computer system 500 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user' s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
synchronously replicating commit records of changed workload data, by one or more processors, from an active site to a bunker site upon a workload data commit; and
asynchronously replicating committed transactions on the changed workload data, by the one or more processors, from the bunker site to a recovery site.

2. The computer-implemented method of claim 1, wherein the changed workload data is replicated with transactional consistency.

3. The computer-implemented method of claim 1, wherein asynchronously replicating the changed workload data further comprises a capture engine communicating with an apply engine to replay database transactions using a database interface to apply the replicated changed workload data to a recovery database at the recovery site.

4. The computer-implemented method of claim 3, wherein the database interface is a structured query language.

5. The computer-implemented method of claim 1, wherein committed changed workload data is replicated from the active site to the recovery site.

6. The computer-implemented method of claim 1, wherein the bunker site is located within tolerable signal latency impact from the active site.

7. The computer-implemented method of claim 1, wherein the recovery site is located beyond tolerable signal latency impact from the active site.

8. A system comprising:
a memory having computer readable instructions; and
one or more processors for executing the computer readable instructions, the computer readable instructions controlling the one or more processors to perform operations comprising:
synchronously replicating commit records of changed workload data from an active site to a bunker site upon a workload data commit; and
asynchronously replicating committed transactions on the changed workload data from the bunker site to a recovery site.

9. The system of claim 8, wherein changed workload data is replicated with transactional consistency.

10. The system of claim 8, wherein asynchronously replicating the changed workload data further comprises a capture engine communicating with an apply engine to replay database transactions using a database interface to apply the replicated workload data to a recovery database at the recovery site.

11. The system of claim 10, wherein the database interface is a structured query language.

12. The system of claim 8, wherein committed changed workload data is replicated from the active site to the recovery site.

13. The system of claim 8, wherein the bunker site is located within tolerable signal latency impact from the active site.

14. The system of claim 8, wherein the recovery site is located beyond tolerable signal latency impact from the active site.

15. A computer program product comprising a computer readable storage medium having program instructions embodied therewith, the program instructions executable by a processor to cause the processor to perform operations comprising:
synchronously replicating changed commit records of workload data from an active site to a bunker site upon a workload data commit; and
asynchronously replicating committed transactions on changed workload data from the bunker site to a recovery site.

16. The computer program product of claim 15, wherein changed workload data is replicated with transactional consistency.

17. The computer program product of claim 15, wherein asynchronously replicating the changed workload data further comprises a capture engine communicating with an apply engine to replay database transactions using a database interface to apply the replicated workload data to a recovery database at the recovery site.

18. The computer program product of claim 15, wherein committed changed workload data is replicated from the active site to the recovery site.

19. The system of claim 15, wherein the bunker site is located within tolerable signal latency impact from the active site.

20. The computer program product of claim 15, wherein the recovery site is located beyond tolerable signal latency impact from the active site.
